(19) United States
(12) Patent Application Publication
(10) Pub. No.: US 2025/0047771 A1
(43) Pub. Date: Feb. 6, 2025

(54) MAGNETIC SINGLE-TO-DUAL SMARTPHONE DEVICE MOUNT

(71) Applicant: Anand Mandaliya, Yorba Linda, CA (US)

(72) Inventor: Anand Mandaliya, Yorba Linda, CA (US)

(21) Appl. No.: 18/792,334

(22) Filed: Aug. 1, 2024

Related U.S. Application Data
(63) Continuation-in-part of application No. 29/944,482, filed on May 28, 2024.
(60) Provisional application No. 63/517,189, filed on Aug. 2, 2023.

(51) Int. Cl. H04M 1/04; B60R 11/00; B60R 11/02

(52) U.S. Cl. CPC H04M 1/04; B60R 2011/0005; B60R 2011/0026; B60R 2011/0056; B60R 2011/0085; B60R 11/0241

(57) ABSTRACT

Provided herein are magnetic single-to-dual device mounts, having: a center rod, having a hollow interior portion, and an opening at the rear end configured to receive an external ball joint into the hollow interior portion; a first ring mount and a second ring mount, each having a ring platform configured to receive an electronic device, a center securing ring, and a ring arm connecting the ring platform to the center securing ring; the center securing ring comprising a central securing ring hole; wherein the ring platform is magnetic and configured to wirelessly charge the electronic device; wherein the first ring mount and the second ring mount are each configured to be rotatable around the center rod when a force is applied to the first ring mount and the second ring mount.

### CROSS-REFERENCE TO RELATED APPLICATIONS

This application claims the benefit of U.S. Provisional Application No. 63/517,189, filed Aug. 2, 2023, and is a continuation-in-part of and claims priority to U.S. Non-Provisional Design Application No. 29/944,482, filed May 28, 2024, each of which are hereby incorporated by reference, to the extent that they are not conflicting with the present application.

### BACKGROUND OF INVENTION

### 1. Field of the Invention:

The invention relates generally to mounting devices and specifically to magnetic mounting devices configured to support multiple smartphones.

### 2. Description of the Related Art

Individuals may carry multiple smartphones to separate personal and business communications, as required by their employer or for any other reasons. Corporate-issued smartphones have proliferated in use as employers focus on ensuring data security, reducing net cost, and mitigating legal & compliance risks. Over the same period of time, advancements in smartphone capabilities (such as Apple MagSafe®) have created new opportunities for individuals to connect their smartphones to device mounts via magnetic technology. Upon surveying the existing smartphone device mount landscape, there appears to be a void for those who wish to concurrently mount both of their smartphones upon a single device mounting apparatus. This is seen across multiple utility scenarios, including, but not limited to, vehicle mounts and free-standing desktop mounts.

As it pertains to vehicle smartphone mounts, in order for a driver to more safely utilize their smartphone while operating a vehicle, it may be necessary for the driver to utilize a mounting device configured to attach to an internal surface of the vehicle. This mounting structure may hold the driver's smartphones in a convenient, safe location to provide the driver with important information, such as driving directions, while in use. While mounting devices for smartphones within vehicles may be present within the marketplace, the usefulness of currently available embodiments of these mounting devices may be limited by several factors.

Currently available device mounts for vehicles may only be configured to support a singular smartphone, whereas the driver may have two smartphones they need to utilize, or a passenger in the vehicle with the driver may also wish to mount their smartphone while driving. may be particularly relevant if the mounting structure also has charging capabilities, as a singular phone mount may only be configured to charge one smartphone at a time. Utilizing multiple mounting devices may not provide a suitable solution to this issue, as additional mounting devices may need to engage with additional car vents, cupholders, different portions of the windshield or dashboard, etc. thus blocking additional vents, blocking use of additional cupholders or further obstructing the driver's view. Furthermore, currently available device mounts for vehicles which may support two smartphones may not be capable of providing magnetic mounting and/or wireless charging capabilities, such as via Apple MagSafe® or any other similar suitable technology while simultaneously allowing users to suitably adjust the positioning and angle of the supported devices based on their needs or preferences, which may be critical to supporting and/or charging a certain supported smartphone. The utilization of multiple mounting devices may be particularly problematic in embodiments in which the mounting device is also configured to charge the mounted smartphone, as additional power cords will need to be plugged into the vehicle, and additional wires may be present, creating additional clutter within the vehicle. Similarly, such problems may be present in other use cases or scenarios such as when charging a mounted smartphone on a desktop or other work surface.

As it pertains to desktop mounts, users may also be in need of a single device mount for securing two smartphones such that both smartphones can be displayed concurrently and with ease of use (including use for virtual meetings). Existing free-standing desktop stands may be provided with only a single ball joint for connecting a smartphone mounting device. However, existing smartphone mounts may only allow for a single smartphone to be mounted and displayed at one time using the free-standing desktop stand.

Therefore, there is a need to solve the problems described above by proving a magnetic single-to-dual smartphone device mounting structure for supporting multiple smartphones within a vehicle, desktop, or in other scenarios, while allowing for adjustment of the position and angle of each smartphone.

The aspects or the problems and the associated solutions presented in this section could be or could have been pursued; they are not necessarily approaches that have been previously conceived or pursued. Therefore, unless otherwise indicated, it should not be assumed that any of the approaches presented in this section qualify as prior art merely by virtue of their presence in this section of the application.

### BRIEF INVENTION SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In some embodiments, a magnetic single-to-dual device mount is provided, comprising: a center rod comprising: a front end, a rear end, a breaker situated between the front end and the rear end, at least two slits along a longitudinal axis of the center rod, assembly grooves at the front end around an exterior surface of the center rod, clamp grooves at the rear end around the exterior surface of the center rod, a hollow interior portion, and an opening at the rear end configured to receive an external ball joint into the hollow interior portion; a first ring mount and a second ring mount; the first ring mount and the second ring mount each comprising: a ring platform configured to receive an electronic device, a center securing ring, and a ring arm connecting the ring platform to the center securing ring; the center securing ring comprising a central securing ring hole, and comprising serrations along an interior circumference of the center securing ring around the central securing ring hole; wherein the ring platform is magnetic, and wherein the first ring mount and the second ring mount each comprise a central ring platform hole; a clamp configured to screw onto the clamp grooves and tighten the center rod; and a front end cap configured to screw onto the assembly grooves; wherein the first ring mount and the second ring mount are each configured to be rotatable around the center rod when a force is applied to the first ring mount and the second ring mount.

Thus, an advantage is that two smartphones (of the same or different makes and models) may be magnetically secured in an ideal location from a singular mounting device. Another advantage is that these two smartphones may also be charged simultaneously, while only occupying a single charger slot within a vehicle or desktop. Another advantage is that the magnetic single-to-dual device support may be configured to rotate such that the supported smartphones may be easily rotated between portrait mode and landscape mode, as needed. Another advantage is that the magnetic single-to-dual device mount may be configured to engage with a corresponding portion of a surrounding vehicle in order to be positioned within the driver's view while they are driving, without significantly blocking the driver's view of the road. Another advantage is that the magnetic single-to-dual device mount may be configured to allow quick and easy hands-free access to one or two smartphones while using a desk or other workplace setting.

The above aspects or examples and advantages, as well as other aspects or examples and advantages, will become apparent from the ensuing description and accompanying drawings.

### BRIEF DESCRIPTION OF THE DRAWINGS

For exemplification purposes, and not for limitation purposes, aspects, embodiments or examples of the invention are illustrated in the figures of the accompanying drawings, in which:

FIG. 1 depicts a side perspective view of a magnetic single-to-dual device mount, in a first exemplary state, according to an aspect.

FIGS. 2A-2B depict a front elevation view and a rear elevation view, respectively, of a magnetic single-to-dual device mount, according to an aspect.

FIGS. 2C-2D depict a top plan view and a bottom plan view, respectively, of a magnetic single-to-dual device mount 700, according to an aspect.

FIGS. 3A-3B depict a right side elevation view and a left side elevation view, respectively, of a magnetic single-to-dual device mount, according to an aspect.

FIG. 4A depicts a front elevation view of a magnetic single-to-dual device mount 700 with the two arms 774 of the ring mounts in another exemplary state, according to an aspect.

FIGS. 4B-4C depict a front elevation view of the magnetic single-to-dual device mount with the two arms of the ring mounts in another exemplary state showing the device mount excluding smartphones, and including smartphones attached to each one of the two ring mounts, respectively, according to an aspect.

FIG. 5 depicts a bottom, side perspective view of a magnetic single-to-dual device mount with the two arms in another exemplary state, according to an aspect.

FIGS. 6A-6B depict a right side elevation view of a magnetic single-to-dual device mount with a rear clamp attached, and with the rear clamp detached, respectively, according to an aspect.

FIGS. 7A-7B depicts a front, side perspective exploded view, and a rear, side perspective exploded view, respectively, of the magnetic single-to-dual device mount, according to an aspect.

FIGS. 8A-8B depict a side view of a magnetic single-to-dual device mount with a rear clamp and an external ball joint detached, and with a rear clamp and an external ball joint attached, respectively, according to an aspect.

FIGS. 9A-9B are two exemplary rear, side perspective views depicting the assembly step depicted in FIG. 8A of the magnetic single-to-dual device mount with a ball joint of a tablet screen and car air vent, respectively, according to an aspect.

FIGS. 10A-10B depict various side elevation views of a fully assembled magnetic single-to-dual device mount secured to a ball joint of a car windshield mount and dashboard mount, according to an aspect.

FIG. 11 is a side elevation view depicting a fully assembled magnetic single-to-dual device mount secured to a ball joint of a desktop stand, according to an aspect.

FIGS. 12A-12C depict various view of a magnetic single-to-dual device mount configured to be used with a magnetic wireless charging system (such as Apple MagSafe), according to an aspect.

### DETAILED DESCRIPTION

What follows is a description of various aspects, embodiments and/or examples in which the invention may be practiced. Reference will be made to the attached drawings, and the information included in the drawings is part of this detailed description. The aspects, embodiments and/or examples described herein are presented for exemplification purposes, and not for limitation purposes. It should be understood that structural and/or logical modifications could be made by someone of ordinary skills in the art without departing from the scope of the invention. Therefore, the scope of the invention is defined by the accompanying claims and their equivalents.

It should be understood that, for clarity of the drawings and of the specification, some or all details about some structural components or steps that are known in the art are not shown or described if they are not necessary for the invention to be understood by one of ordinary skills in the art.

Provided herein are single-to-dual device mounts for holding electronics such as smartphones. In some embodiments, the single-to-dual device mounts are configured for holding one or two smartphones. In some embodiments, the single-to-dual device mounts are configured for holding one or two smartphones by a magnetic connection. In some embodiments, the single-to-dual device mounts are configured for holding electronic devices such as smartphones and securing the device mount to a surface. In some embodiments, the single-to-dual device mounts can be secured to an interior of a vehicle. In some embodiments, the single-to-dual device mounts can be secured to another object that is used for holding, storing, mounting, or displaying smartphones on another surface such as a surface of a desk or other piece of furniture. In such embodiments, the object may be a tripod, or any other suitable stand or holder.

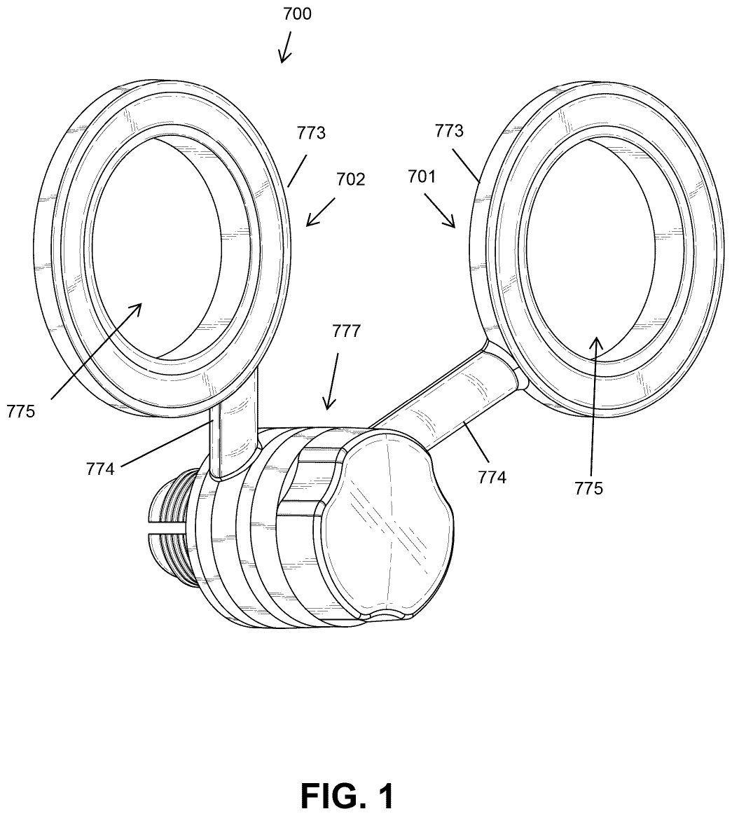

FIG. 1 depicts a side perspective view of a magnetic single-to-dual smartphone device mount (“device mount”) 700, in a first exemplary state, according to an aspect. It should be understood that the device mounts disclosed herein are generally configured to hold either a single smartphone or two smartphones at once. In order to facilitate the holding of two smartphones on a unified mounting structure (such as one within a vehicle or on a desktop), the device mount (700 may be configured to securely engage with each smartphone through a corresponding magnetic connection. In some embodiments, the magnetic connection is provided on mounting platforms, as further described below.

In some embodiments, the mounting platforms may be provided as ring mounts, such as a first ring mount 701 and a second ring mount 702. Each ring mount may be magnetic for securing a single smartphone. In some embodiments, the body of the ring mounts 701, 702 may contain a magnetic plate internally. Each ring platform of the two ring mounts may be sufficiently sized to be securely engaged with a magnetic interface on a supported smartphone (or a supported protective case of such smartphone). As such, each ring platform of each ring mount may be made of a sufficiently magnetic material or be configured to contain such material to facilitate magnetic engagement between the supported smartphone and the device mount 700.

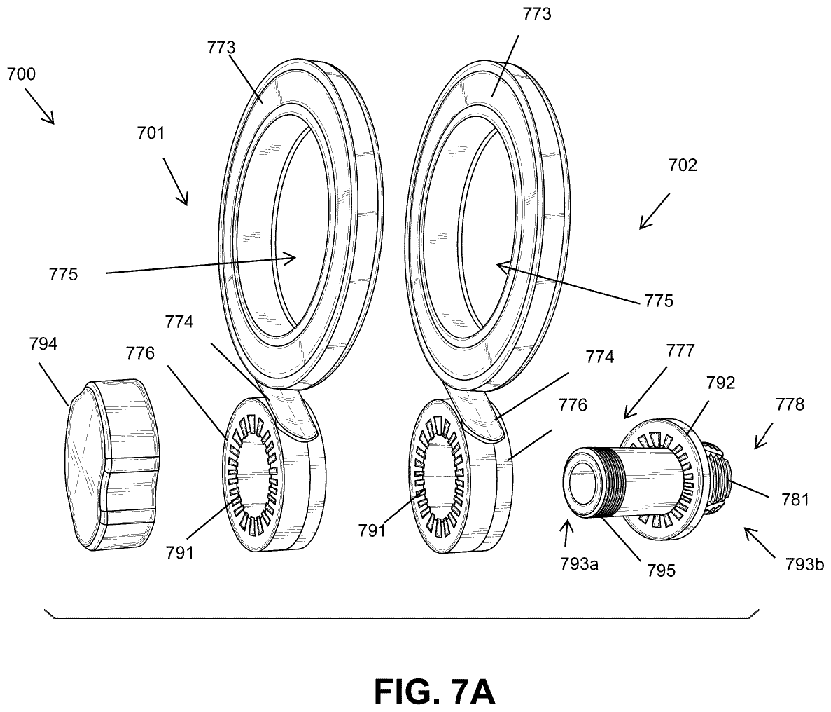

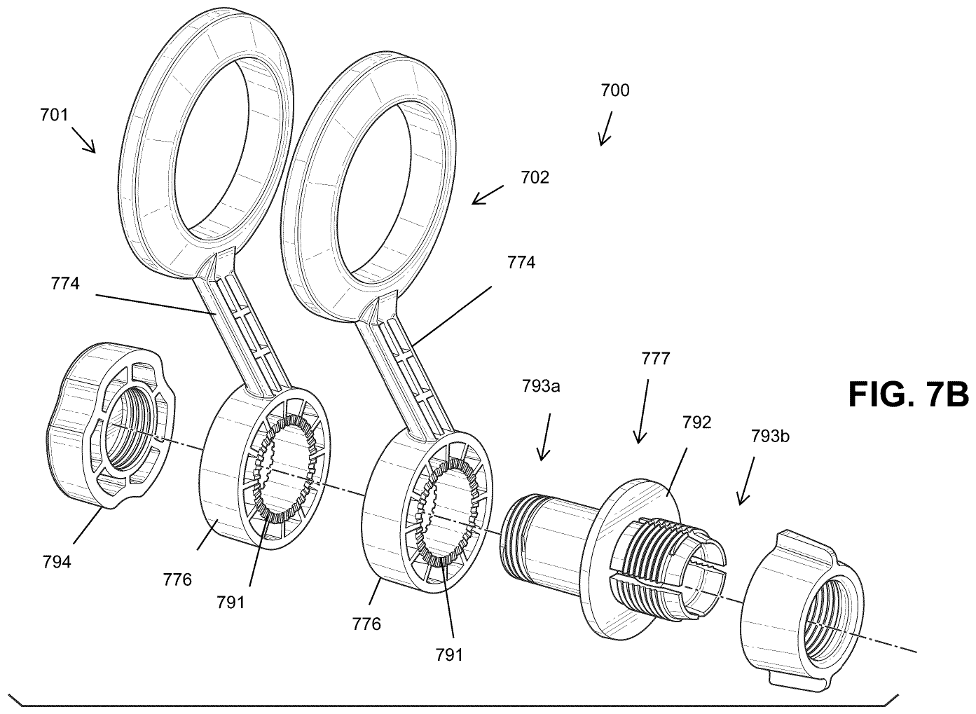

The device mounts disclosed herein may include ring mounts that have a ring platform 773 associated with a ring arm 774. The ring arm 774 may further be associated with additional components that allow for associating the ring mounts to the center rod, disclosed in further detail herein, such as when referring to element 777 of at least FIGS. 7A-7B.

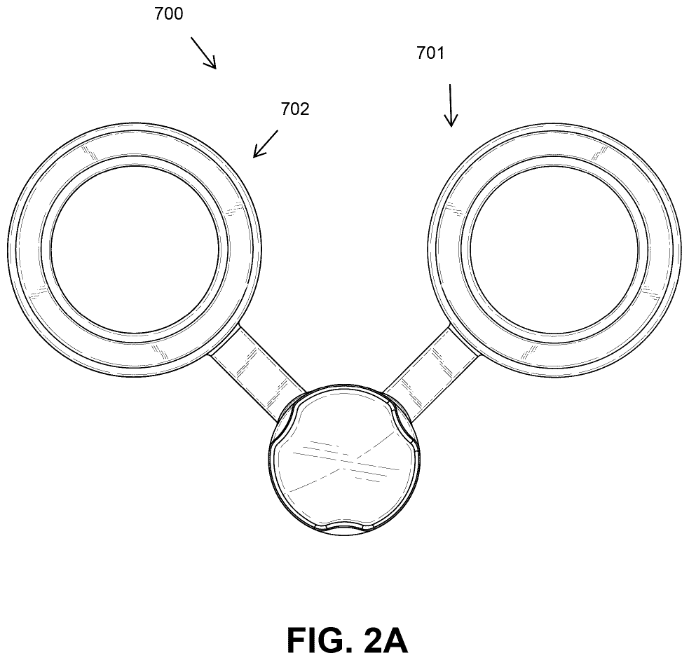

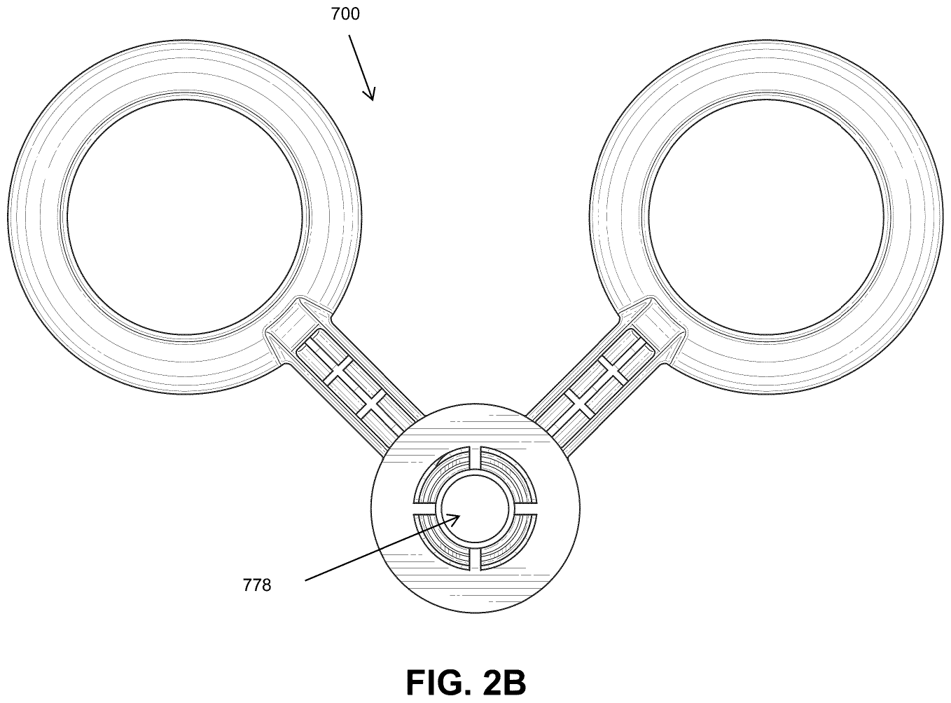

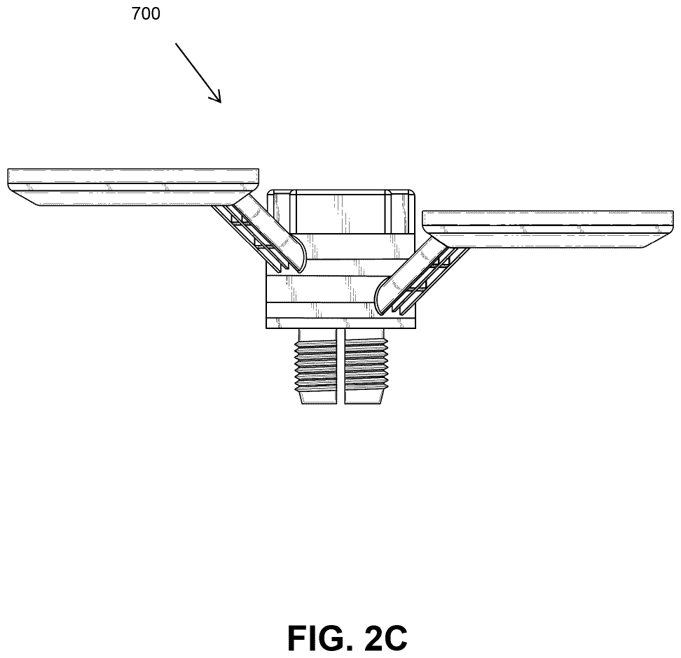

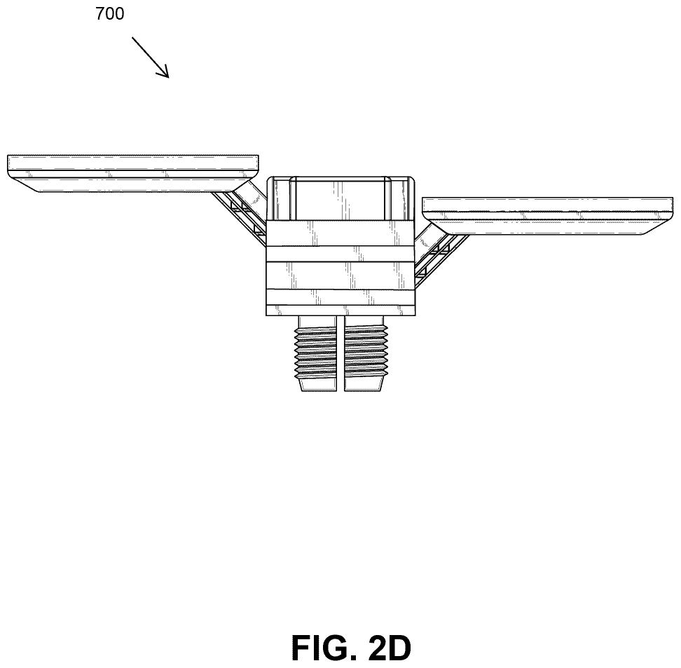

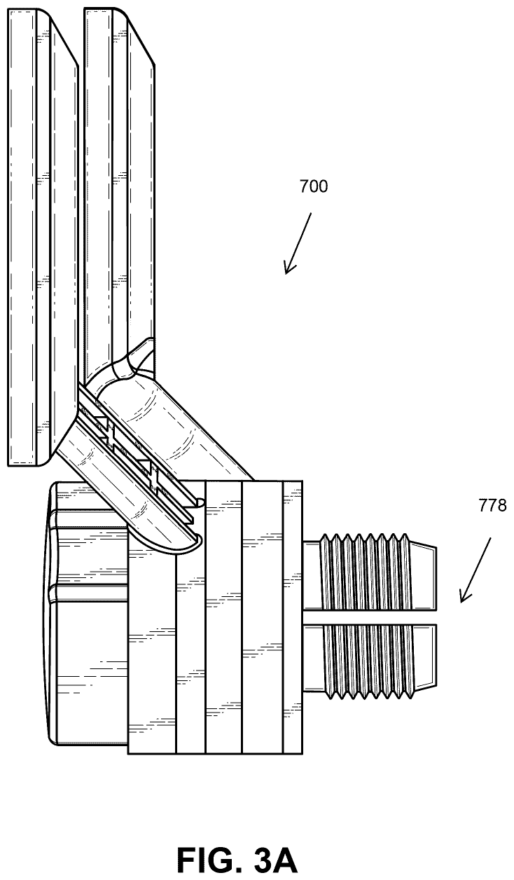

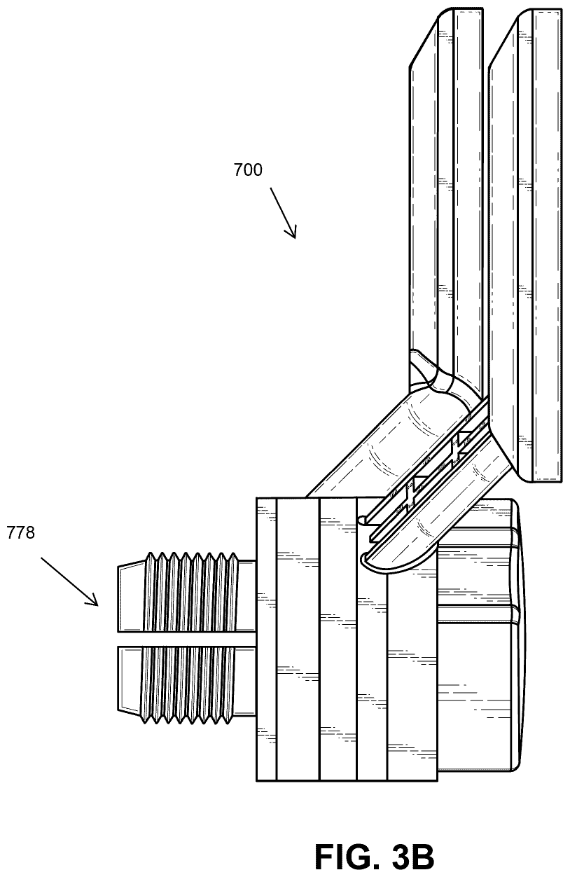

FIGS. 2A-2B depict a front elevation view and a rear elevation view, respectively, of a device mount 700, according to an aspect. The view depicted shows the two ring mounts in the first exemplary state as depicted in FIG. 1. The rear view of the device mount, as depicted in FIG. 2B, and shown in additional detail in FIGS. 3A-3B, shows an opening 778 configured to receive a ball joint. The ball joint could be of any suitable external mounting device or platform having a ball joint (including, but not limited to, a dashboard mount, windshield mount, air vent mount, desktop mount, and tablet mount), and being configured to be secured or rested on any suitable other item or surface, for example. As an example, the ball joint could be a standard 17 mm size ball joint.

It should be understood that the ball joint 444 may be associated with any suitable device useful for mounting to a surface or any other method of holding a smartphone. These may be referred to generally as a “mount support.” For example, the ball joint 444 may be associated with a mount support having a suction cup, which can be useful for engaging with a window or other glass surface, such as a vehicle windshield.

It should be understood that regardless of the mount support utilized to engage the mounted devices with the vehicle, said mount support should be positioned as to place the supported devices sufficiently in view of the driver without needing to turn their head or take their eyes off the road, while also being positioned to not significantly obstruct the driver's view of the road. As an example, the positioning of a configuration utilizing a suction cup support may be limited to locations having surfaces that suction cup is configured to engage with, including a windshield, dashboard, side windows, or other surfaces capable of established a suction based connection with the suction cup. As such, through suitable positioning of a mount support mounted devices supported by the mount may remain visible to the driver while removing the need for the driver to deviate from a forward-facing position to view/use the device. It should be understood that the rotational engagement of each ring arm 774 may allow the supported devices to be rotated into a variety of positions, depending on the driver's preference. For example, supported smartphones could be transitioned easily between landscape and portrait orientations.

FIGS. 2C-2D depict a top plan view and a bottom plan view, respectively, of a device mount 700, according to an aspect.

FIGS. 3A-3B depict a right-side elevation view and a left-side elevation view, respectively, of a device mount 700, according to an aspect. As discussed above when referring to FIG. 2B, the rear end of the device may comprise an opening 778 configured to receive a ball joint.

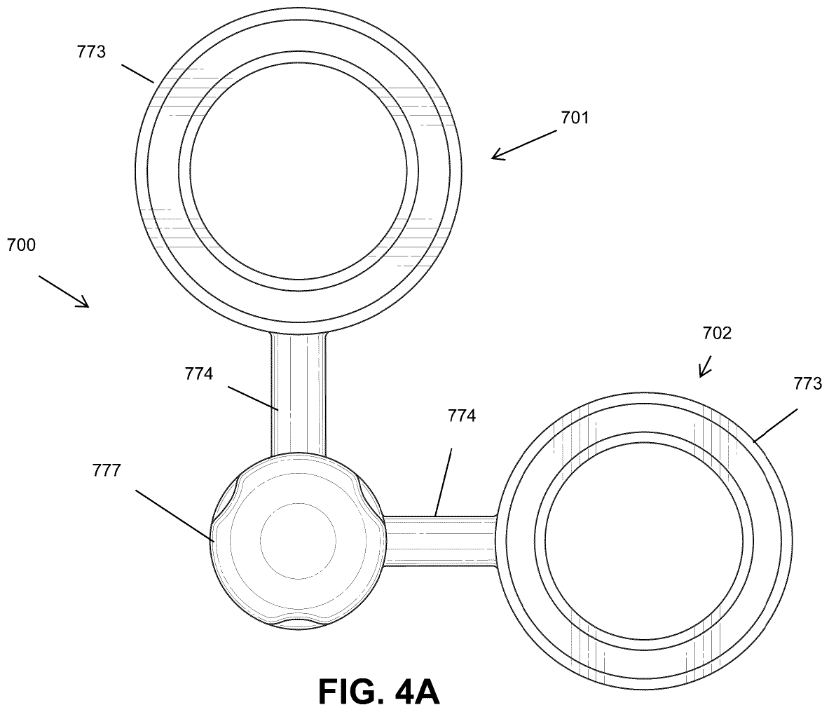

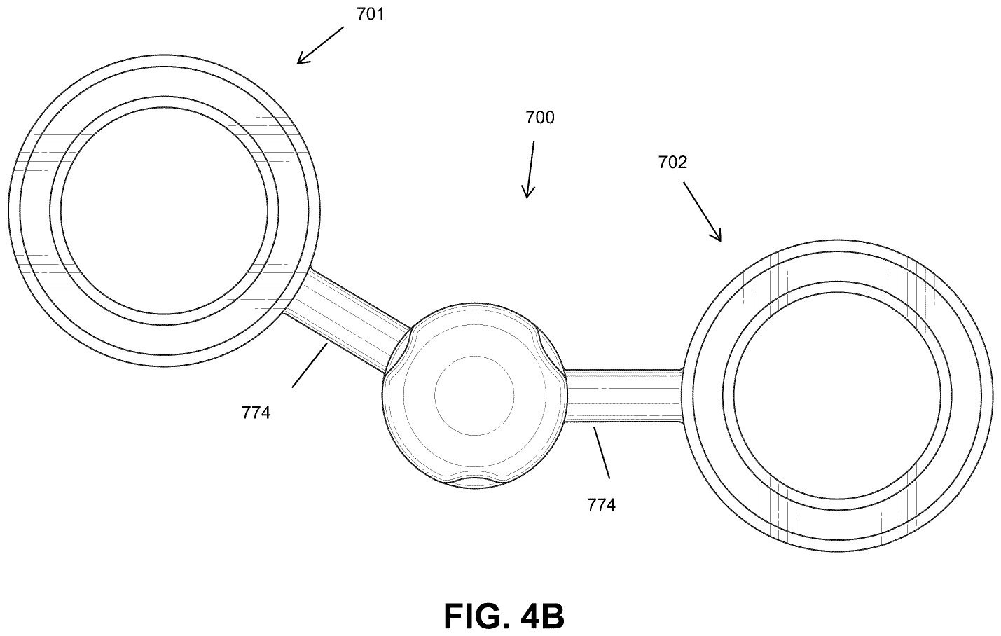

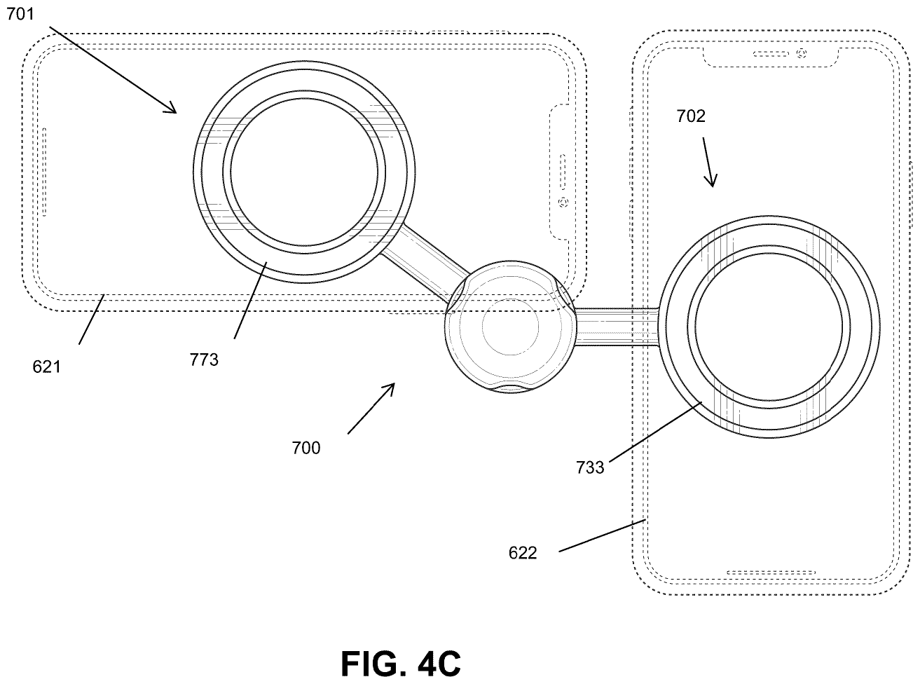

FIG. 4A depicts a front elevation view of a device mount 700 with the two arms 774 of the ring mounts in another exemplary state, according to an aspect. The two ring mounts 701 and 702 may be configured such that they can rotate around a center rod 777 (discussed in further detail herein). The two ring mounts 701, 702 may each independently of each other rotate around the center rod fully in 360° such that they can be oriented in any desired position, such as in a state where the first ring mount 701 is situated away from the second ring mount 702, as such as an example in FIG. 1. In such a state, the device mount 700 can display two smartphones at once. Other configurations may also be possible for any of the device mounts disclosed herein.

Because the ring platform 773 of each ring mount contains a magnet, a smartphone can be secured to the rings in any orientation and can be moved into any desired position on the ring. The second exemplary dual-smartphone state is a “three o′clock” position, wherein the first ring mount 701 pointed towards what would be the 12 of a standard clock and the second ring mount 702 pointed towards what would be the 3 of a standard clock. It should therefore be understood that the two ring mounts may be positioned in any desired configuration and that the two ring mounts do not necessarily need to be symmetrical with each other about the center rod 777.

FIGS. 4B-4C depict a front elevation view of the magnetic dual device mount 700 with the two arms 774 of the ring mounts in another exemplary state showing the device mount excluding smartphones, and including smartphones attached to each one of the two ring mounts, respectively, according to an aspect. As shown, each ring mount 701, 702 may be magnetic and can hold a smartphone 621, 622. Because the entire ring platform 773 of each ring mount may be magnetic or contain an internal magnet that is contained within the entire circumference of the ring platform, a smartphone 621, 622 can be magnetically secured to each ring mount in any configuration or orientation. For example, the first smartphone 621, attached to the first ring mount 701 is shown in a horizontal position, while the second smartphone 622 is shown in a vertical position. It should therefore be understood that the device mount 700 may be used for configuring not only the ring arms in any desired position, but also for configuring the smartphones magnetically attached to the ring platforms in any desired position in a 360° orientation on the ring platforms 773.

Accordingly, it should be understood that the device mounts disclosed herein could be provided in a variety of configurations and embodiments, such as the embodiment depicted in at least FIGS. 1-4D.

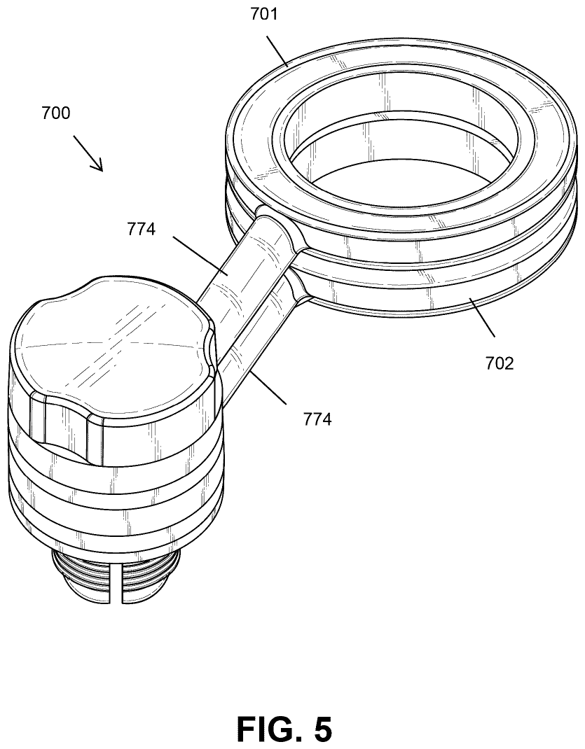

FIG. 5 depicts a bottom, side perspective view of a device mount 700 with the two arms 774 in another exemplary state, according to an aspect. As discussed when referring to FIG. 1, the two ring mounts may rotate to be positioned according to a user's needs. As such, the exemplary state shown in FIG. 5 could be used for mounting a single smartphone.

In some embodiments, the mounting platforms disclosed herein may be rotatable such that a first mounting platform 701 can be positioned in front of a second mounting platform 702 such that, when viewed from a front elevation view, only the first ring mount 701 is visible, and such that the device mount appears to only provide a mounting platform for one smartphone. This configuration illustrates a single-smartphone orientation, which may be used in order to minimize spacing or for a cleaner appearance when the need to mount only one smartphone arises. This single-smartphone orientation resembles that of a standard, single smartphone mount.

This may be useful for situations where mounting only a single smartphone is needed for the user. The ability to position the ring mounts in such a manner can be useful for saving space when only one ring mount is needed. Accordingly, one device mount may be used for transitioning between single smartphone mounting use, and dual smartphone mounting use, and therefore, a single solution can be provided to users whether they are in need of displaying and mounting only one smartphone or two smartphones.

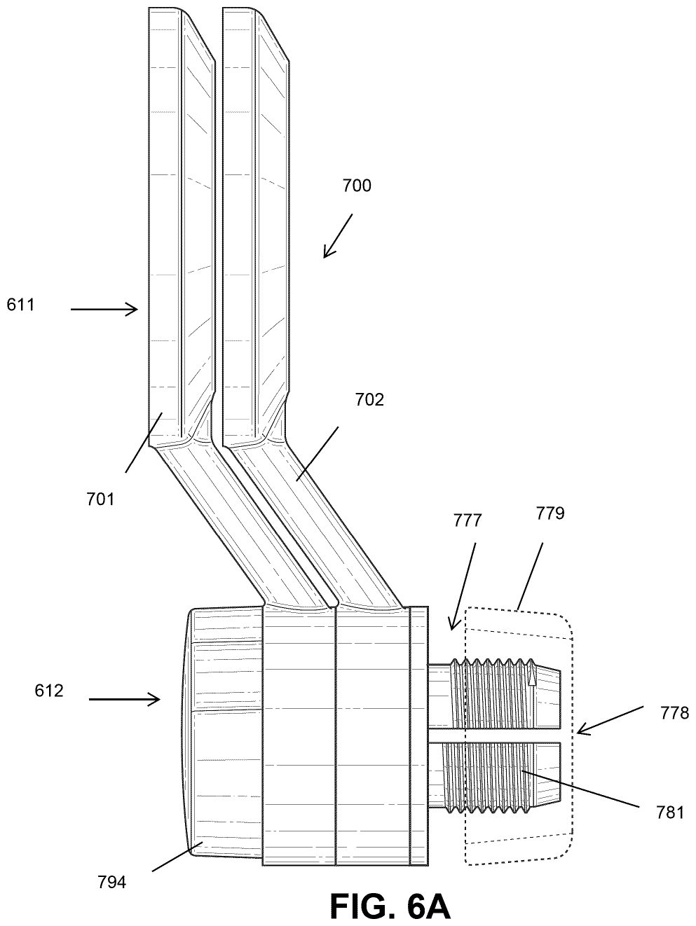

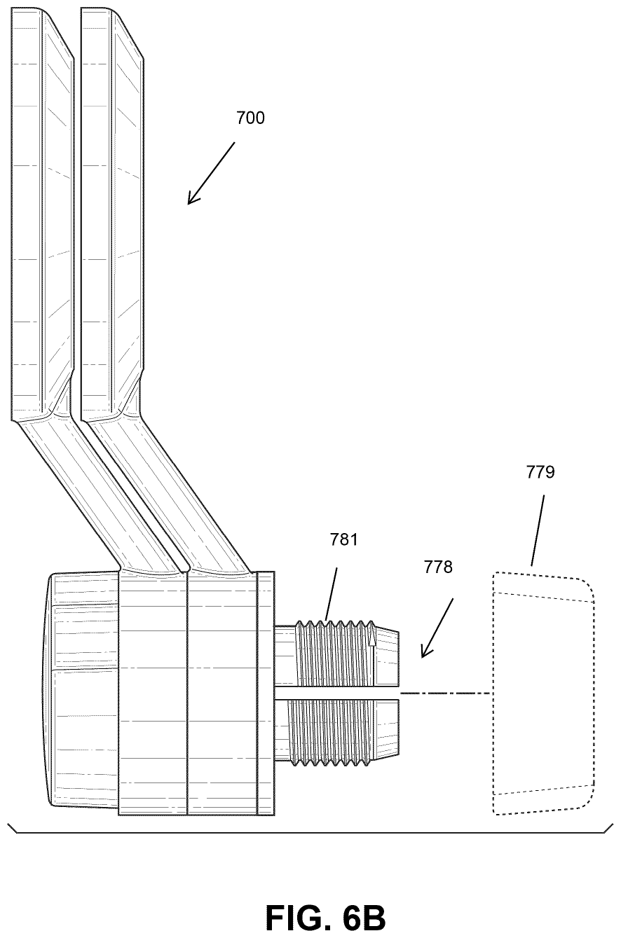

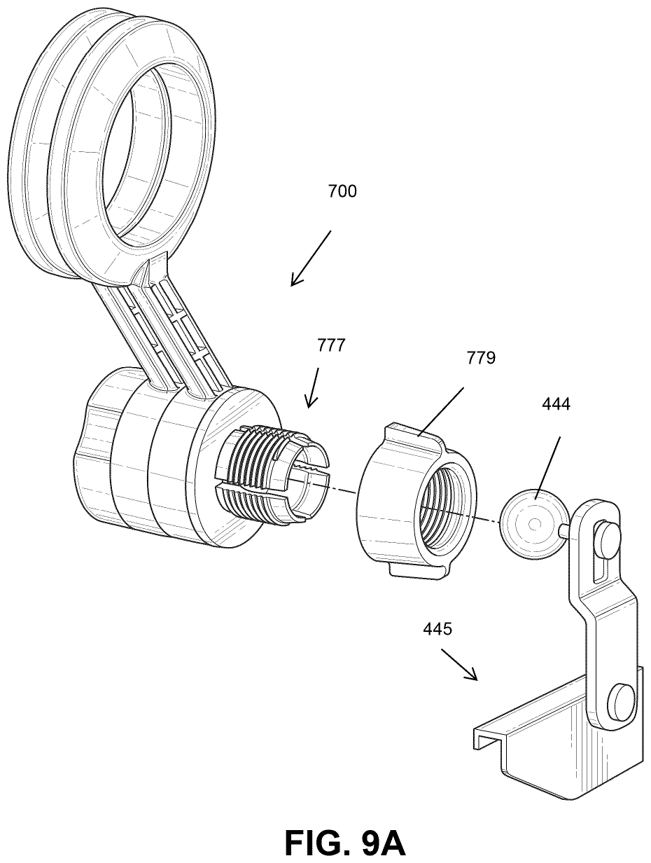

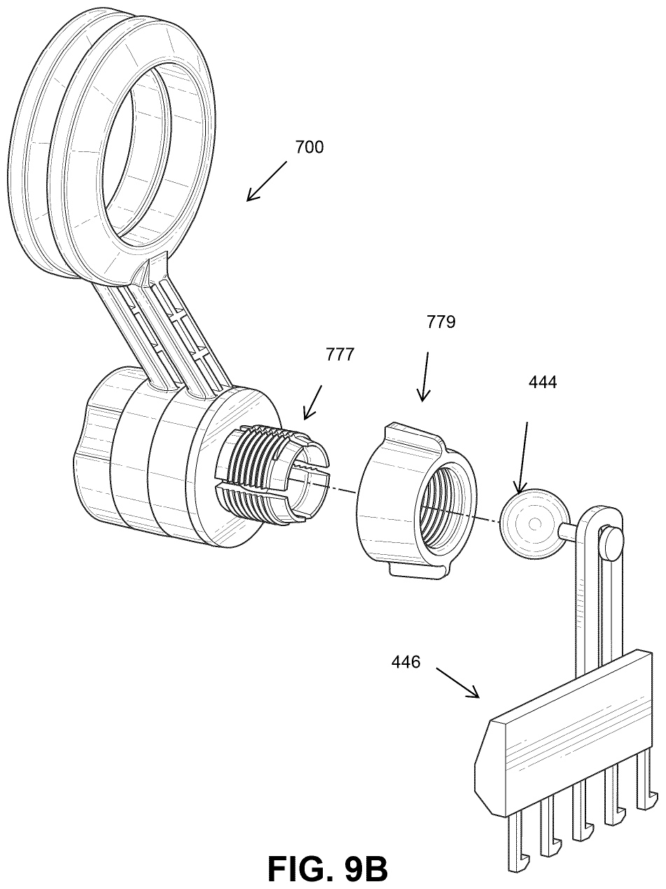

FIGS. 6A-6B depict a right side elevation view of a device mount 700 with a rear clamp attached, and with the rear clamp detached, respectively, according to an aspect. The rear clamp 779 is depicted in broken lines for visual clarity to show how the rear clamp fastens over the rear clamp grooves 781 of the center rod 777, which surround the opening 778 for receiving a ball joint. The rear clamp 779 is depicted in solid lines in at least FIGS. 7B and 9A-9B. In some embodiments, the rear clamp 779 is placed onto an external ball joint, and the ball joint is received into the opening 778. Next, the rear clamp 779 can be twisted onto the rear clamp grooves 781 to tighten the connection and secure the ball joint to the device mount 700 in order for the device mount to remain in a static, fixed position as desired by the user, with enough tension to withstand the weight of the mounting device 700 and two smartphones when fully engaged.

Generally, the first ring mount 701 is oriented towards the front end of the device mount 700, and the second ring mount 702 is oriented towards the rear end of the device mount. As can be seen in the side elevation view of FIG. 6A, the front side 611 of the first ring mount 701 is generally flush with or at least slightly extends over the front side 612 of a front end cap 794, which is configured to fasten over the assembly of the components on the center rod of the device mount (described in further detail herein when referring to at least FIGS. 7A-7B). This allows for a smartphone mounted to the first ring mount 701 to be positioned in any orientation (e.g., vertical or horizontal) without being obstructed by the front end cap 794.

FIGS. 7A-7B depicts a front, side perspective exploded view, and a rear, side perspective exploded view, respectively, of the device mount 700, according to an aspect. In some embodiments, a device mount is disclosed, having several components that fit together and can be secured together. The components may include at least the following. The device may include a first ring mount 701, and a second ring mount 702. Each ring mount may include a ring platform 773 which may be magnetic or contain an internal magnet. Each ring platform may be a circular ring with a center hole 775 configured to receive a wireless charging pad, for example. Each ring platform 773 may be associated with a ring arm 774. Each ring arm may be associated with a center securing ring 776, with each center securing ring 776 having serrations 791 along an interior section of the center securing ring.

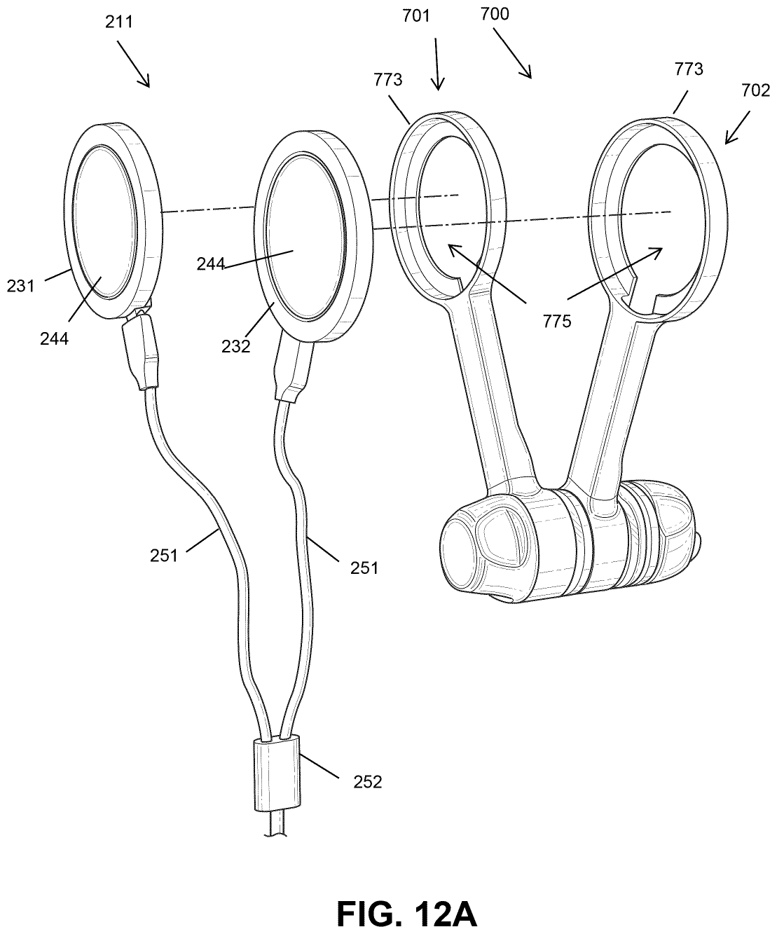

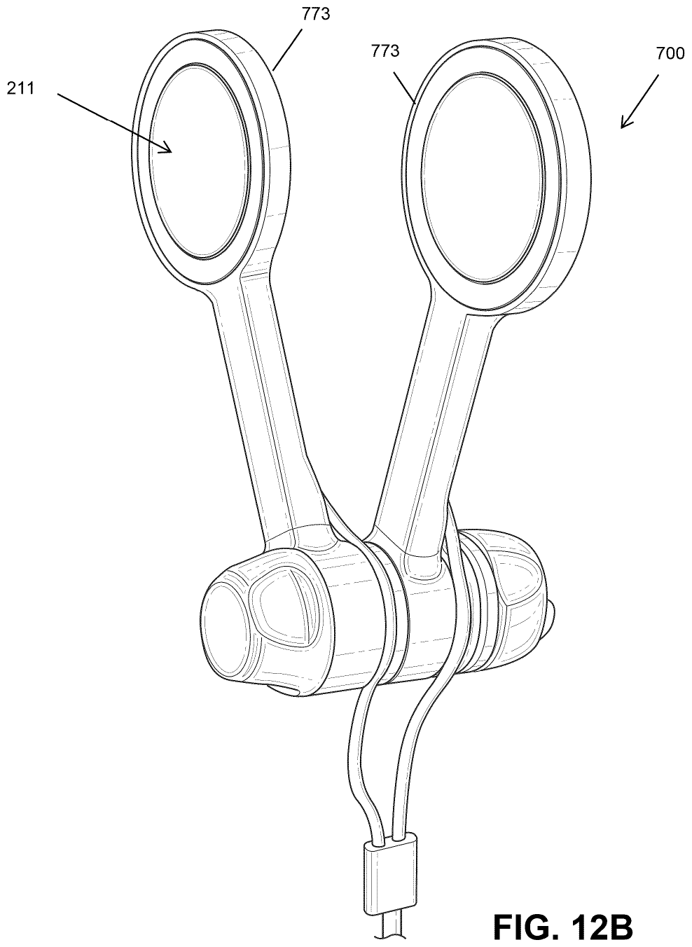

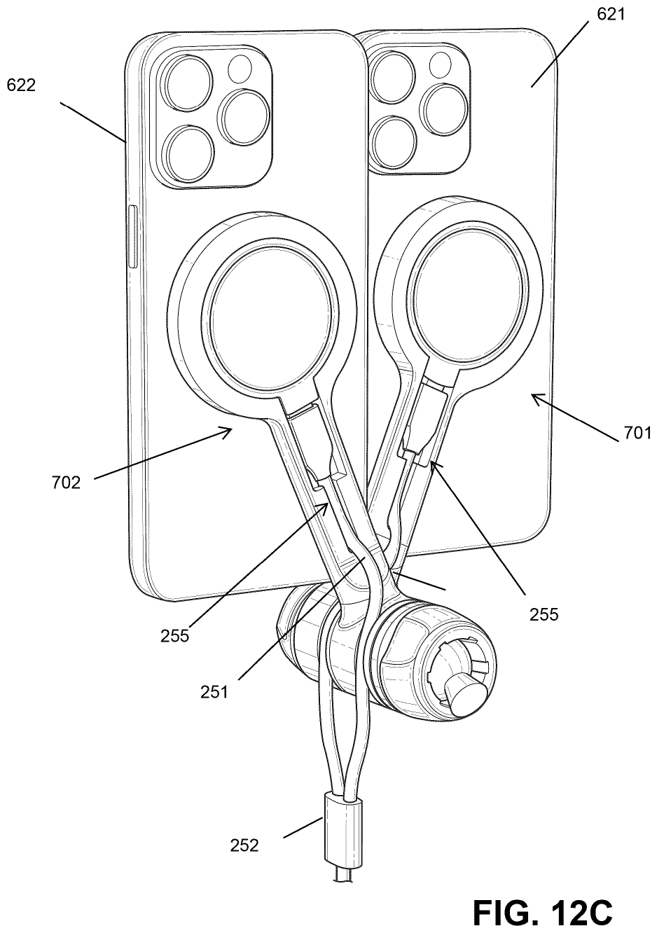

The device may also include a center rod 777 having a front end 793a and a rear end 793b. The center rod 777 may include clamp grooves 781 for a rear clamp (shown in at least FIGS. 12A-12B) on the rear end, an opening 778 on the rear end for receiving an external ball joint, a breaker 792 in between the front end and the rear end. The center rod 777 may also include assembly grooves 795 at the front end, configured to aid in assembly of the device via front cap 794. The center rod may be configured to receive each one of the center securing rings 776 of the ring mounts, such that the ring mounts can each be placed in line on the center rod. The serrations 791 of the center securing rings may allow for the ring mounts to rotate around the center rod, and remain in the position at which the user desires when placed into a particular configuration. That is, when a force is applied to the first ring mount or the second ring mount, such as a user holding the device and moving one or both ring mounts around on the center rod, the ring mounts may rotate into a desired position. Once the ring mounts are positioned as desired, the serrations 791 may aid in keeping the ring mounts in the desired position until the ring mounts are moved again by the user. Accordingly, the center rod is configured to fit with the back of the rings, which slide onto the center rod one by one.

Both sides of the center securing rings 776 may comprise of serrated edges. The back of the center securing rings 776 may comprise of serrated male edge, while the front may comprise a female side. These components may be provided such that the two center securing rings can lock in when pushed together onto the center rod 777. There are an array of serrations around the ring mounts 701 and 702 to accommodate different orientation states, while ensuring sufficient grip. The second ring mount 702 can be placed on the center rod 777 and next, the first ring mount 701 can be placed on the center rod 777, by inserting the center securing rings of each ring mount through the center rod 777. The ring mounts may be separated from the rear or back end 793b of the center rod by the breaker 792. Finally, a front end cap 794 then can twist onto the assembly grooves 795 on the front end of the device to secure both ring mounts in their desired positions on the center rod.

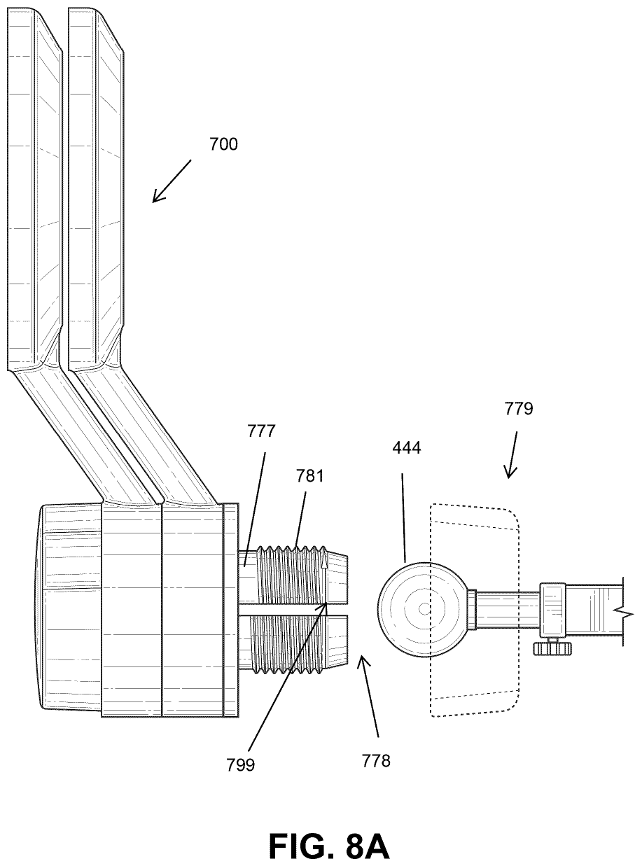

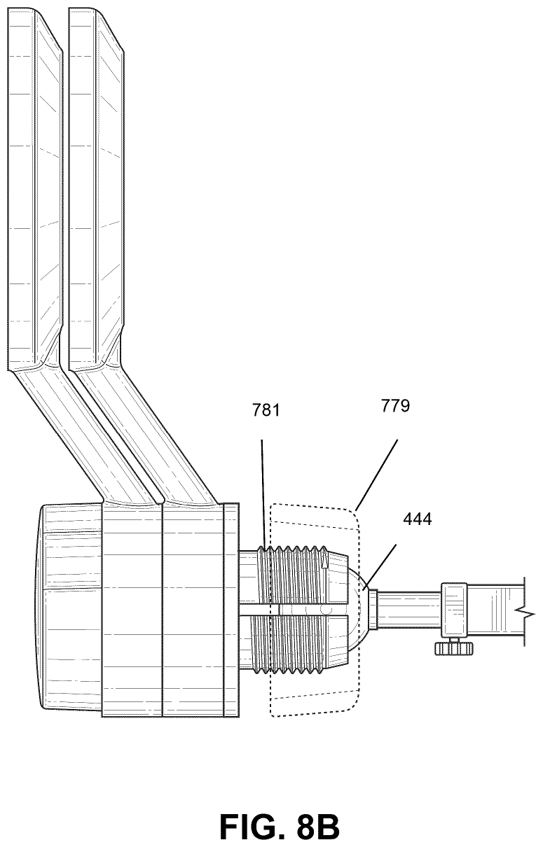

FIGS. 8A-8B depict a side view of a device mount with a rear clamp and an external ball joint detached, and with a rear clamp and an external ball joint attached, respectively, according to an aspect. In some embodiments, the device mount 700 disclosed herein may be secured to an object, platform, piece of furniture, interior of a vehicle, or any other suitable surface by securing the device mount to an external device having a ball joint 444. Once the device mount is secured to the ball joint, the device mount can then positioned on the ball joint 444, before securing the desired configuration into place by tightening the rear clamp 779. Prior to tightening the rear clamp, a user may have a certain amount of freedom to tilt the device mount around on the ball joint, and find a desired position, and then tightening the device mount against the ball joint into that desired position by twisting the rear clamp 779 further around the clamp grooves 781. First, the rear clamp 779 can be placed on the ball joint 444. Next, the ball joint can be received into the opening 778 of the rear end of the device mount and into a hollow interior portion of the center rod 777. The center rod may include slits 799 along a longitudinal axis, such that the center rod is generally flexible when receiving the ball joint. Accordingly, the center rod 777 may be constructed from any suitable material that is sturdy, durable, and has enough strength to hold the device mount and attached smartphones, while also having enough flexibility to slightly expand and receive a ball joint 444. Once the ball joint 444 is received into the center rod 777, the center rod may be strong enough to securely snap over the ball joint and hold it in place. The rear clamp 779 may then be twisted onto the clamp grooves 781 of the center rod 777 to secure these components into place.

FIGS. 9A-9B are two exemplary rear, side perspective views depicting the assembly step depicted in FIG. 8A of the device mount 700 with a ball joint 444, according to an aspect. It should be understood that the ball joint 444 could be associated with any suitable device. As an example, FIG. 9A shows a ball joint attached to a mount support 445 intended for clipping or securing to a screen. The screen could be any screen, such as a screen in the interior of a vehicle, tablet, or a laptop screen, for example. It should also be understood that the rear clamp 779 may be of any suitable shape or configuration for securing or tightening the center rod 777 around the ball joint 444. As another example, FIG. 9B shows a ball joint attached to a mount support 446 intended for securing to an air vent of a vehicle interior (such as those designed in Tesla vehicles), for example.

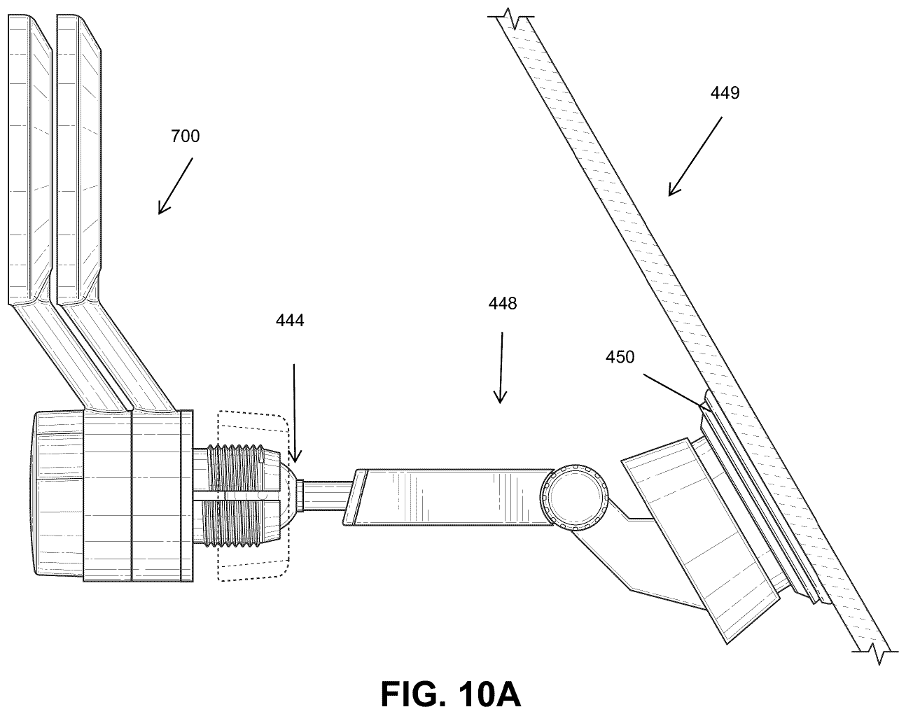

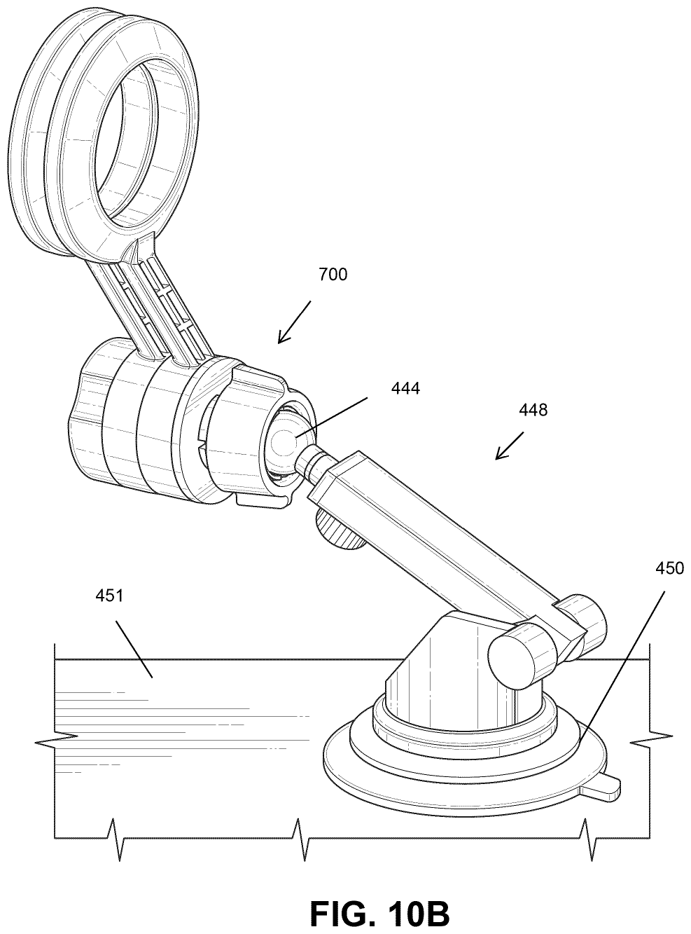

FIGS. 10A-10B depict various side elevation views of a fully assembled device mount 700 secured to a mount support 448 having a ball joint 444, according to an aspect. As previously discussed, it should be understood that any kind of mount support having a ball joint may be used with any of the device mounts disclosed herein. For example, a mount support having a suction cup 450 may be used to attach to a device mount, wherein the device mount is oriented on the ball joint 444 such that the suction cup can be attached to a windshield 449 of a vehicle, as depicted in FIG. 10A. Alternatively, the device mount may be oriented on the ball joint of the mount support 448 such that the suction cup 450 can be placed on a flat surface 451, such as a desk or vehicle dashboard, and smartphones mounted to the device mount can be at an appropriate orientation for a user viewing the smartphones while the mount support is on a flat surface 451, as depicted in FIG. 10B.

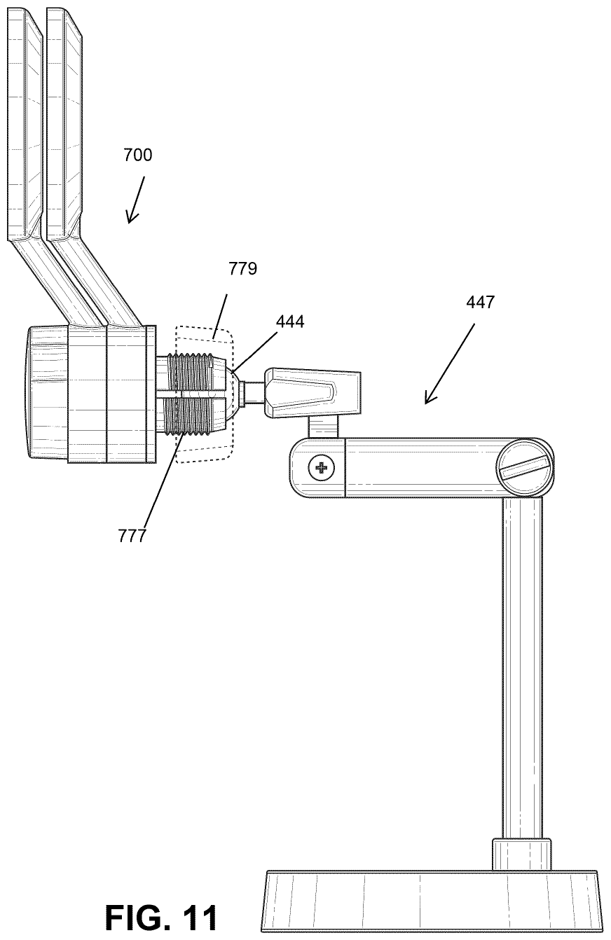

FIG. 11 is a side elevation view depicting a fully assembled device mount 700 secured to a ball joint 444, according to an aspect. The rear clamp 779 is depicted in broken lines solely for visual clarity such that the assembly of the ball joint 444 within the center rod 777 may be shown. It should also be understood that the ball joint 444 could be associated with a mount support for use on a desktop or any other suitable surface. As an example, the ball joint 444 of FIG. 11 is shown associated with a mount support 447 that can be free-standing on a desk, table, or any other surface. Accordingy, it should be understood that the device mount may be used for a variety of purposes, and should not be limited to the interior of a vehicle.

FIGS. 12A-12B depict various views of a device mount 700 configured to be used with a magnetic, wireless charging system 211, according to an aspect. FIG. 12A shows a front, side perspective view of device mount 700 and a magnetic, wireless charging system 211 in a disassembled state, and FIG. 12B shows a front, side perspective view of the device mount 700 and the magnetic, wireless charging system 211 in an assembled state.

In some embodiments, each ring mount may also comprise wireless charging capability for charging the device that is magnetically attached to the ring mounts. In some embodiments, the device mount may be provided without wireless charging capability, and each ring mount may comprise a magnetic plate configured to magnetically engage with a supported device without charging it. In some embodiments, the device mounts may be provided with a center hole 775 which may be configured to fit and hold a component for a wireless charging system, such as the exemplary system shown in FIGS. 12A-12C. In such embodiments, the device mounts may be used with or without the wireless charging components according to a user's needs. As such, it should be understood that wireless charging may be provided as a component of the magnetic dual device mounts disclosed herein, or may be omitted from the structure of the dual device mount for applications in which charging of the supported device(s) is not required or desirable.

As discussed herein, the device mounts disclosed herein may comprise a first ring mount 701 and a second ring mount 702, each ring mount having ring platform 773 with a center hole 775. In some embodiments, the device mounts disclosed herein may be configured to fit together with a magnetic, wireless charging system 211 (again, such as the exemplary system shown in FIGS. 12A-12C). The center holes 775 may be entirely hollow to accommodate a portion of the magnetic, wireless charging system 211. In such embodiments, the magnetic, wireless charging system 211 may be provided with a first charging pad holder 231 and a second charging pad holder 232. Each charging pad holder 231, 232 may be configured to surround and engage with a charging pad 244 having magnetic, wireless charging capability. For example, each charging pad 244 may be equipped with Apple MagSafe® technology or any other suitable or comparable technology. The charging pad holders 231, 232 may be configured to be surrounded by and engaged with their corresponding ring platforms. That is, the first charging pad holder 231 may be configured to be held within the center hole 775 of the first ring mount 701, and the second charging pad holder 232 may be configured to be held within the center hole 775 of the second ring mount 702. Each charging paid 244 may receive a charging cable 251 which could be a single charging cable having a cable splitter 252 such that a single charging cable can connect to both charging pads.

FIG. 12C depicts a rear perspective view of the device mount 700 and the magnetic, wireless charging system 211 in an assembled state, and holding two smartphones, according to an aspect. A first smartphone 621 is magnetically secured on the first ring mount 701, and a second smartphone 622 is magnetically secured on the second ring mount 702. In some embodiments, the ring arms of each ring mount may be provided with an insert area 255 for receiving a charging cable 251. This may help for space saving and neatness as well as cable management when using the device mount 700 with a wireless charging system. A single charging cord having a cable splitter 252 may be used with the configuration to facilitate charging two smartphones at once, supported by the device mount. As such each charging plate may be in electrical communication with a singular shared power source, to minimize excess cords and excess charging port usage.

The shape and characteristics of each mounting platform 701, 702 may be the same or different depending on the needs of the application. For example, the positioning of a magnetic charging surface on different makes and models of smart phone may vary. As such, the size, positioning and other characteristics (e.g., strength of magnetic engagement) of the charging plate and/or magnetic plate on each mounting platform 701, 702 may be modified in accordance with the smartphones to be supported, or provided in a manner to provide broad support for different makes and models of smartphones. If each mounting platform is configured to support a smartphone without charging it, the charging plate may not be provided with charging capabilities or may be omitted entirely, leaving the magnetic plate to support the held smartphone.

It may be advantageous to set forth definitions of certain words and phrases used in this patent document. The term “couple” and its derivatives refer to any direct or indirect communication between two or more elements, whether or not those elements are in physical contact with one another. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Further, as used in this application, “plurality” means two or more. A “set” of items may include one or more of such items. Whether in the written description or the claims, the terms “comprising,” “including,” “carrying,” “having,” “containing,” “involving,” and the like are to be understood to be open-ended, i.e., to mean including but not limited to. Only the transitional phrases “consisting of” and “consisting essentially of,” respectively, are closed or semi-closed transitional phrases with respect to claims.

If present, use of ordinal terms such as “first,” “second,” “third,” etc., in the claims to modify a claim element does not by itself connote any priority, precedence or order of one claim element over another or the temporal order in which acts of a method are performed. These terms are used merely as labels to distinguish one claim element having a certain name from another element having a same name (but for use of the ordinal term) to distinguish the claim elements. As used in this application, “and/or” means that the listed items are alternatives, but the alternatives also include any combination of the listed items.

Throughout this description, the aspects, embodiments or examples shown should be considered as exemplars, rather than limitations on the apparatus or procedures disclosed or claimed. Although some of the examples may involve specific combinations of method acts or system elements, it should be understood that those acts and those elements may be combined in other ways to accomplish the same objectives.

Acts, elements and features discussed only in connection with one aspect, embodiment or example are not intended to be excluded from a similar role(s) in other aspects, embodiments or examples.

Aspects, embodiments or examples of the invention may be described as processes, which are usually depicted using a flowchart, a flow diagram, a structure diagram, or a block diagram. Although a flowchart may depict the operations as a sequential process, many of the operations can be performed in parallel or concurrently. In addition, the order of the operations may be re-arranged. With regard to flowcharts, it should be understood that additional and fewer steps may be taken, and the steps as shown may be combined or further refined to achieve the described methods.

If means-plus-function limitations are recited in the claims, the means are not intended to be limited to the means disclosed in this application for performing the recited function, but are intended to cover in scope any equivalent means, known now or later developed, for performing the recited function.

Claim limitations should be construed as means-plus-function limitations only if the claim recites the term “means” in association with a recited function.

If any presented, the claims directed to a method and/or process should not be limited to the performance of their steps in the order written, and one skilled in the art can readily appreciate that the sequences may be varied and still remain within the spirit and scope of the present invention.

Although aspects, embodiments and/or examples have been illustrated and described herein, someone of ordinary skills in the art will easily detect alternate of the same and/or equivalent variations, which may be capable of achieving the same results, and which may be substituted for the aspects, embodiments and/or examples illustrated and described herein, without departing from the scope of the invention. Therefore, the scope of this application is intended to cover such alternate aspects, embodiments and/or examples. Hence, the scope of the invention is defined by the accompanying claims and their equivalents. Further, each and every claim is incorporated as further disclosure into the specification.

What is claimed is:

1. A magnetic single-to-dual device mount, comprising:
a front body end, a rear body end;
a center rod comprising:
a front end, a rear end, a breaker situated between the front end and the rear end, at least two slits along a longitudinal axis of the center rod, assembly grooves at the front end around an exterior surface of the center rod, clamp grooves at the rear end around the exterior surface of the center rod, a hollow interior portion, and an opening at the rear end configured to receive an external ball joint into the hollow interior portion;
a first ring mount oriented towards the front body end, and a second ring mount oriented towards the rear body end; the first ring mount and the second ring mount each comprising:
a ring platform, a center securing ring, and a ring arm connecting the ring platform to the center securing ring; the center securing ring comprising a central securing ring hole, and comprising serrations along an interior circumference of the center securing ring around the central securing ring hole;
wherein the center securing ring is configured to fit on the center rod; and
wherein the ring platform comprises a magnet, wherein the first ring mount and the second ring mount each comprise a central ring platform hole; and
wherein the ring platform is configured to receive an electronic device via a magnetic connection provided by the magnet;
a rear clamp configured to screw onto the clamp grooves and tighten the center rod; and
a front end cap configured to screw onto the assembly grooves;
wherein the first ring mount and the second ring mount are each configured to be rotatable around the center rod when a force is applied to the first ring mount and the second ring mount.

2. The magnetic single-to-dual device mount of claim 1, wherein the first ring mount is flush with the front end cap at the front body end.

3. The magnetic single-to-dual device mount of claim 1, wherein the first ring mount extends past the front end cap at the front body end.

4. The magnetic single-to-dual device mount of claim 1, wherein the first ring mount and the second ring mount each are configured to receive a component of a wireless charging system.

5. The magnetic single-to-dual device mount of claim 3, wherein the wireless charging system comprises a first charging pad, a second charging pad, a first charging pad holder, and a second charging pad holder, and wherein the first charging pad holder is configured to be surrounded and held by the ring platform of the first ring mount, and wherein the second charging pad holder is configured to be surrounded and held by the ring platform of the second ring mount.

6. The magnetic single-to-dual device mount of claim 1, wherein the center securing ring comprises a female connection at the front body end, and the center securing ring comprises a male connection at the rear body end, such that the second ring mount is configured to receive the first ring mount on the front body end of the second ring mount.

7. The magnetic single-to-dual device mount of claim 1, wherein the first ring mount and the second ring mount are each configured to be rotatable 360° around the center rod.

8. The magnetic single-to-dual device mount of claim 1, wherein the breaker is configured to separate the first ring mount and the second ring mount from the clamp grooves and the clamp.

9. A magnetic single-to-dual device mount, comprising:
a front body end, a rear body end;
a center rod comprising:
a front end, a rear end, a breaker situated between the front end and the rear end, a hollow interior portion, and an opening at the rear end configured to receive an external ball joint into the hollow interior portion;
a first ring mount and a second ring mount; the first ring mount and the second ring mount each comprising:
a ring platform configured to receive an electronic device, a center securing ring configured to fit on the center rod, and a ring arm connecting the ring platform to the center securing ring; the center securing ring comprising a central securing ring hole;
wherein the ring platform is magnetic;
wherein the first ring mount and the second ring mount are each configured to be rotatable around the center rod when a force is applied to the first ring mount and the second ring mount.

10. The magnetic single-to-dual device mount of claim 9, wherein the first ring mount and the second ring mount are each configured to be rotatable 360° around the center rod.

11. The magnetic single-to-dual device mount of claim 9, wherein the center securing ring comprises a female connection at the front body end, and the center securing ring comprises a male connection at the rear body end, such that the second ring mount is configured to receive the first ring mount on the front body end of the second ring mount.

12. The magnetic single-to-dual device mount of claim 9, comprising a front end cap configured to screw onto the center rod at the front body end.

13. The magnetic single-to-dual device mount of claim 12, wherein the first ring mount is flush with the front end cap at the front body end.

14. The magnetic single-to-dual device mount of claim 12, wherein the first ring mount extends past the front end cap at the front body end.

15. A magnetic single-to-dual device mount, comprising:
a center rod comprising:
a hollow interior portion, and an opening at a rear end configured to receive an external ball joint into the hollow interior portion;
a first ring mount and a second ring mount; the first ring mount and the second ring mount each comprising:
a ring platform configured to receive an electronic device, a center securing ring configured to fit on the center rod, and a ring arm connecting the ring platform to the center securing ring; the center securing ring comprising a central securing ring hole, and comprising serrations along an interior circumference of the center securing ring around the central securing ring hole;
wherein the ring platform is magnetic, and wherein the first ring mount and the second ring mount each comprise a central ring platform hole;
a rear clamp configured to screw onto the center rod at the rear body end; and
a front end cap configured to screw onto the center rod at the front body end;
wherein the first ring mount and the second ring mount are each configured to be rotatable around the center rod when a force is applied to the first ring mount and the second ring mount.

16. The magnetic single-to-dual device mount of claim 15, wherein the first ring mount and the second ring mount each comprise wireless charging capability.

17. The magnetic single-to-dual device mount of claim 15, wherein the first ring mount and the second ring mount are each configured to be rotatable 360° around the center rod.

18. The magnetic single-to-dual device mount of claim 15, wherein the external ball joint is configured to secure to a portion of a vehicle interior.

19. The magnetic single-to-dual device mount of claim 15, wherein the external ball joint is configured to secure to a free-standing device.

20. The magnetic single-to-dual device mount of claim 15, wherein the first ring mount and the second ring mount each are configured to receive a component of a wireless charging system.
